(19) United States
(12) Patent Application Publication
(10) Pub. No.: US 2020/0008349 A1
(43) Pub. Date: Jan. 9, 2020

(54) Replaceable component rotary lawnmower blade

(71) Applicant: Jimmy BOLLMAN, Oklahoma City, OK (US)

(72) Inventor: Jimmy BOLLMAN, Oklahoma City, OK (US)

(21) Appl. No.: 15/998,119

(22) Filed: Jul. 3, 2018

(51) Int. Cl. A01D 34/73

(52) U.S. Cl. CPC A01D 34/733; A01D 2101/00

(57) ABSTRACT

A rotary lawnmower blade having replaceable blade components pivotally attaching to a blade base provides a user with a plurality of cutting edges and cut margins and also to provide replaceable blade components which may be bought in bulk for keeping a sharp edge available without having to replace and entire blade or sharpen a dull blade.

### CROSS REFERENCE TO RELATED APPLICATIONS

None.

### BACKGROUND OF THE INVENTION

### 1. Field of Invention

A rotary lawnmower blade having replaceable blade components pivotally attaching to a blade base provides a user with a plurality of cutting edges and cut margins and also to provide replaceable blade components which may be bought in bulk for keeping a sharp edge available without having to replace and entire blade or sharpen a dull blade.

### 2. Description of Prior Art

A preliminary review of prior art patents was conducted by the applicant which reveal prior art patents in a similar field or having similar use. However, the prior art inventions do not disclose the same or similar elements as the present replaceable cutting edge rotary lawnmower blade, nor do they present the material components in a manner contemplated or anticipated in the prior art. A disc mower blade that provides a plurality of radial teeth with a sharp presenting margin to be used on a roadside mower, with a central disc attaching numerous radial teeth for cutting grass, shown in U.S. Design Pat. D579126 and U.S. Patent Publication No. 2013/0111863 to Johnson. A dual cutting margin blade is shown in U.S. Patent Publication No. 2013/0199148 to Coudeau, Jr. An adjustable length rotary mower blade is shown in U.S. Pat. No. 5,791,131 to Hill which provides a component assembled rotary lawnmower blade, but the extending cutting margin adjusts for length, but does not provide for pivotal rotation, which deflects force and pivots away from the blade body in the event of impact with a hard object.

The present component rotary blade provides a fixed blade body attached to rotary shaft of the rotary lawnmower with pivotally attaching dual cutting margin blade components, which can be flipped to present a fresh cutting margin when the other cutting margin becomes dull, and also accepts replacement blade components to support a variety of cutting edge shapes or lawn grass accessories.

### SUMMARY OF THE INVENTION

Lawnmower blades attach below the deck of a rotary lawnmower to a central shaft. These blade are most often provided as a hard piece of rectangular metal which has a sharp edge on the presenting margin of the bilaterally symmetrical blade to provide the blade with balance and cutting qualities. Over time the blades become dull and require either sharpening or replacement with sharpening capable of throwing of the balance of the blade which can damage the mower, or blade replacement which is expensive and requires the user to use tools and effort to turn the mower on its side to access the blade being replaced, which may be difficult to do if the nut holding the blade is stuck or frozen. It is also difficult to maintain the blade stationary while attempting to remove the screw.

The primary objective of the present component blade is to provide easy replacement or a dual cutting margin to either quickly refresh the cutting edge, to provide more than one blade cutting margin configuration and to easily replace each component blade by removal of a single retaining screw which provides a fresh sharp blade as often an necessary. A secondary objective is to provide the component blade in pivotal attachment to minimize damage from impact with a hard object during use, allowing the blade component to pivot away from the impact object to reduce the amount of force being delivered to the cutting margin over that of a fixed blade cutting margin striking the same hard object. A third objective is to prevent the use from having to remove the entire blade during exchange which requires more effort to stabilize the blade for removal of the central nut on the mower shaft over that required to remove the pivotal blade screws used to retain the blade component is pivotal assembly with the blade base on each end.

### DESCRIPTION OF THE DRAWINGS

The following drawings are submitted with this utility patent application.

FIG. 1 is a perspective view of a first embodiment of a replaceable component rotary lawnmower blade.

FIG. 2 is a top view of the first embodiment of the replaceable component rotary lawnmower blade.

FIG. 3 is a side view of the first embodiment of the replaceable component rotary lawnmower blade.

FIG. 4 is a sectional view of the replaceable component rotary lawnmower blade along section lines 4/4 of FIG. 2.

FIG. 5 is a sectional view of the pivotal attaching pin assembly for the replaceable component rotary lawnmower blade.

FIG. 6 is a a perspective view of a second embodiment of a replaceable component rotary lawnmower blade.

FIG. 7 is a top view of the second embodiment of the replaceable component rotary lawnmower blade.

FIG. 8 is a side view of the second embodiment of the replaceable component rotary lawnmower blade.

FIG. 9 is a sectional view of the replaceable component rotary lawnmower blade along section lines 9/9 of FIG. 7.

### DESCRIPTION OF THE PREFERRED EMBODIMENT

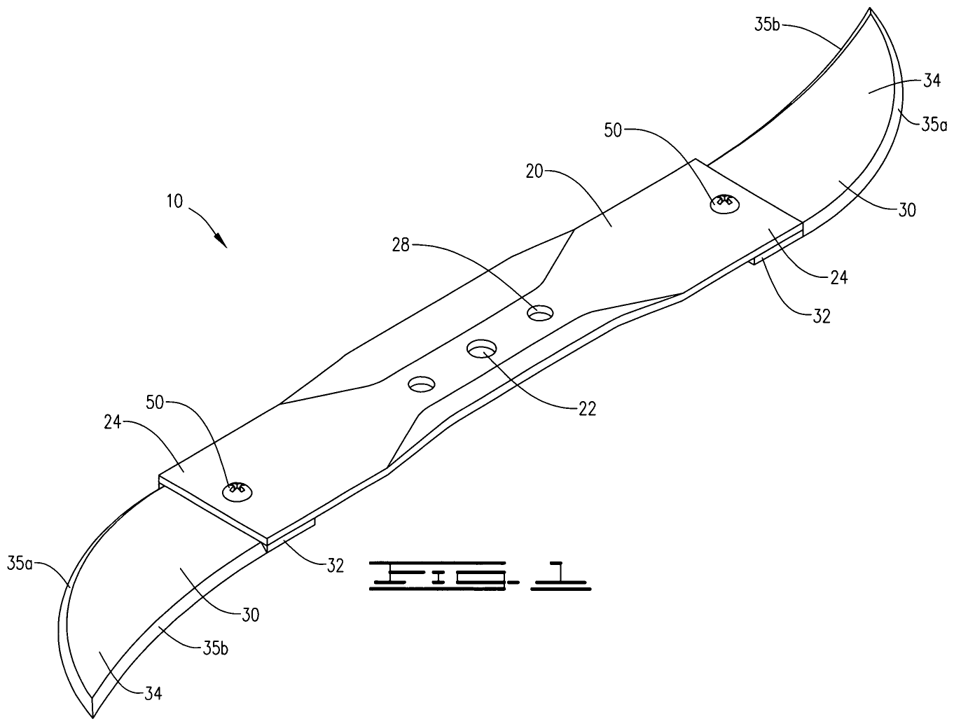

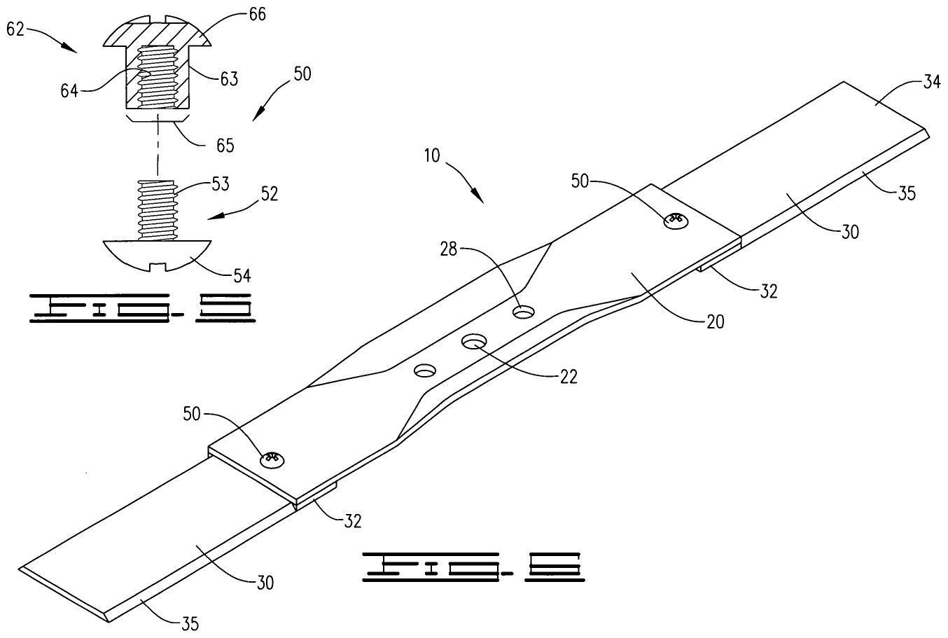

A replaceable component rotary lawnmower blade 10, shown in FIGS. 1-9, provides the blade with a blade base 20, which is bilaterally symmetrical, the blade base 20 defining a central bore 22 through which a shaft bolt B of the lawnmower is mounted, and two opposing ends 24, each end 24 defining a connector pin bore 26 defined within each respective end 24, and a matched pair of replaceable blade components 30 defining a first end 32 having a first end bore 33 through which a connector pin 50 is placed to connect each respective first end bore 33 of each replaceable blade component 30 to a respective connector pin bore 26 on each respective end 24 of the blade base 20 in a pivotal manner, each blade component 30 further defining a second end 34 presenting reversible dual cutting edges 35 on each side of each replaceable blade component 30. Instead of having to remove the one piece lawnmower blade from the lawnmower for sharpening or replacement, the blade base 20 remains attached to the lawnmower shaft A and the blade components 30 may be reversed or exchanged by removal of the connector pin 50 while the blade component 30 is either being replaced with fresh blade components, or the existing blade component 30 is reversed presenting a fresh cutting edge 35 for further mowing.

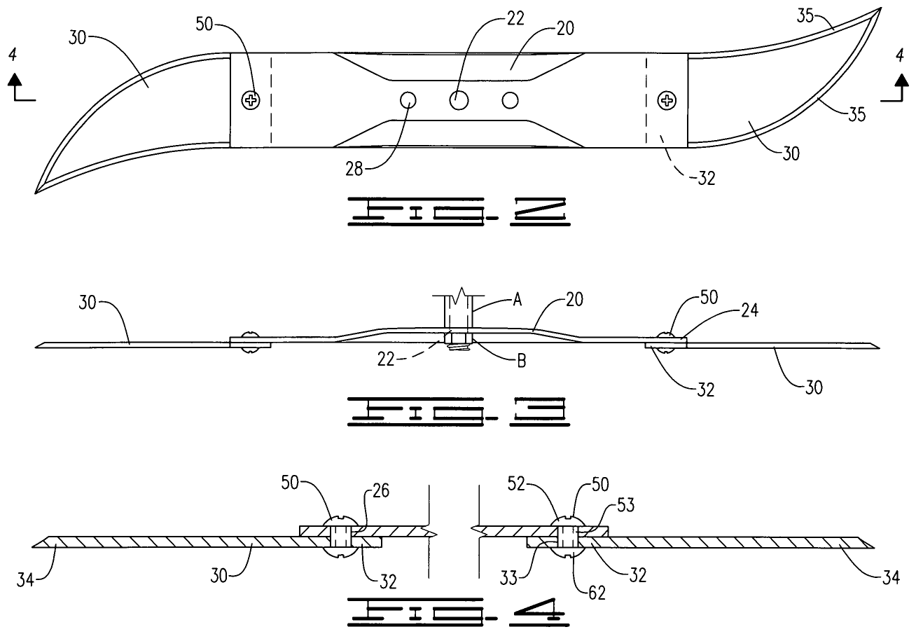

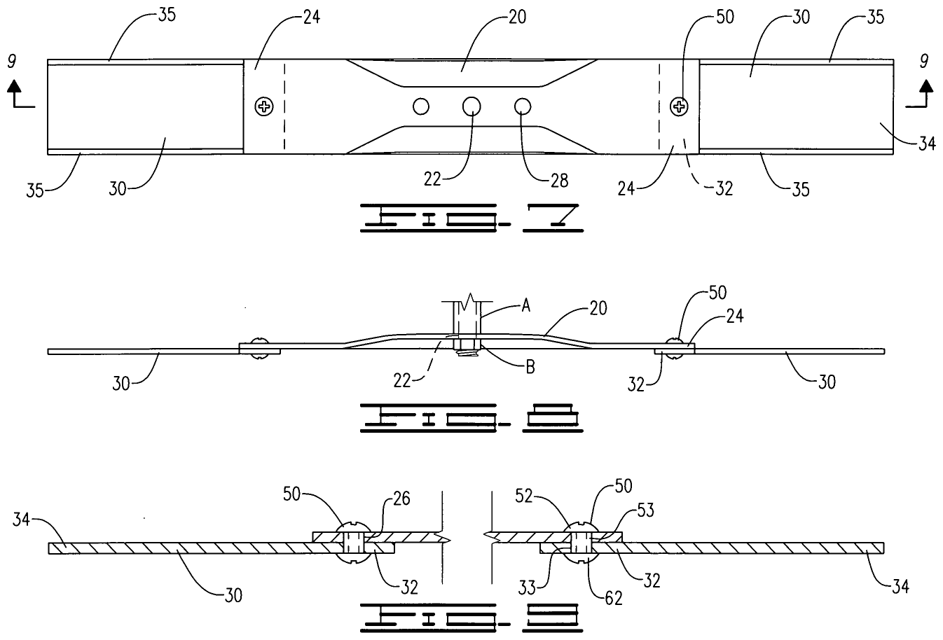

The blade base 20 is a reenforced metal component having an overall rectangular shape and an overall flat profile, as seen in FIGS. 2-4 and 7-9. The placement of the central bore 32 is directly centered to provide uniform balance to the blade base 20 upon being mounted to the lawnmower shaft A, the lawnmower shaft and shaft bolt indicated in FIGS. 3 and 8. There may be alternative mounting holes 28 located adjacent to the central bore 22, depending upon the mounting requirements of the particularly suited lawnmower, as indicated in FIGS. 1-2 and 6-7. The blade base 20 further defines the opposing ends 24, FIGS. 2 and 7, within which the connector pin bores 26 are placed and centered. These connector pin bores 26 provide a location for pivotal connection the replaceable blade components 30 and are connected to the blade base 20 by the respective connector pins 50. The purpose and utility of the connector pin 50 is to provide a connecting means that provides rotational attachment of the replaceable blade component 30, which allows for complete rotational engagement with the blade base 20. This functional full rotational engagement provides for each replaceable blade component 30 to resist impact in the event the replaceable blade component 30 hits a hard or stationary object.

The resulting full rotational engagement provides improved utility features over that of a fully integrated fixed blade in several manners. First, by providing the replaceable blade component 30 in pivotal rotation, the replaceable blade component 30 is more likely to resist deformation and dulling of the presenting cutting edge 35. Second, the replaceable blade components 30 is less likely to propel a hard object from underneath the lawnmower deck due to the pivotal rotation absorbing a portion of the momentum forces generated by a solid lawnmower blade. Third, in the event there is impact with something other than grass, the replaceable blade components 30 may spin completely away from the object after initially striking that object wherein a solid blade may strike that object numerous times. Fourth, by providing the replaceable blade component 30 attaching by the connector pin 50, if the replaceable blade component 30 is damaged, the damaged replaceable blade component may be quickly exchanged with a new one. Fifth, by providing the blade base 20 as one component and the replaceable blade components 30 as another, the blade base 20 is universally applied to any rotatory lawnmower regardless of cutting diameter.

The replaceable blade components 30 attached to the blade base 20 would be variable in length, shape and size which are suitable to the rotary lawnmower cutting diameter to which they are applied. As shown in FIGS. 1-2 the replaceable blade components 30 are sickle shaped and FIGS. 6-7 show the replaceable blade component 30 as rectangular, both embodiments indicating dual cutting margins 35, making each replacement blade component 30 reversible to provide a choice for the user in the case of the sickle shaped replaceable blade components to provide either a concave cutting edge 35b or a convex cutting edge 35a, or in the case of the rectangular replaceable blade component, two identical cutting edges 35 on each.

The connector pin 50, best illustrated in FIGS. 4-5 and 9, would be an example of an ideally suited connector pin for functional purposes. In this embodiment, the connector pin 50 defines a first segment 52 having an outer threaded shaft 53 and an expanded head 54 and a second segment 62 having a smooth shaft pin 63 having an inner threaded bore 64 and an outer perimeter 65 and an expanded head 66. The expanded heads 54, 66, of the first and second segments 52, 62, would have tool indentations for establishing a tight connection. The outer perimeter 65 of the shaft pin 63 would be configured to be inserted within the first end bore 33 of the replaceable blade component 30 and the respective connector pin bore 26 of the blade base 20 with the outer threaded shaft 53 of the first segment 52 then threadably inserted within the inner threaded bore 64 of the second segment 62, securing the replaceable blade component 30 onto the respective end 24 of the blade base 20 while allowing rotation of the replaceable blade component 30 on the blade base 20, but not allowing vibration or lateral movement of either the connector pin bore 26 or the first end bore 33 due to the close proximity fit of the respective bores and the outer perimeter 65 of the smooth shaft pin 63 of the second segment 62, as shown in FIGS. 4 and 9.

While the invention has been particularly shown and described with reference to a preferred embodiment thereof, it will be understood by those skilled in the art that changes in form and detail may be made therein without departing from the spirit and scope of the invention.

What is claimed is:

1. A replaceable component rotary lawnmower blade comprising:
a bilaterally symmetrical blade base defining a central bore accepting a bolt attaching said blade base to a rotary lawnmower shaft, and two opposing ends, each end defining a connector pin bore; and
a matched pair of replaceable blade components defining a first end having a first end bore through which a connector pin is inserted to connect each respective first end bore of each replaceable blade component to a respective connector pin bore on each respective end of the blade base in a pivotal manner, each of said blade components further defining reversible dual cutting edges, wherein said blade base remains attached to said lawnmower while said connector pins are removed as said blade components are either replaced with new replaceable blade components, or said blade components are reversed, presenting a sharp cutting edge for further mowing.

2. The replaceable rotary lawnmower blade of claim 1, further comprising:
said blade base is made of reenforced metal having an overall rectangular shape and an overall flat profile;
said central bore is directly centered to provide uniform balance to said blade base upon being mounted to the lawnmower shaft with alternative mounting holes located adjacent to the central bore, depending upon the mounting requirements of the particularly suited lawnmower;
said opposing ends within which said connector pin bores are placed and centered provide a location for said replaceable blade components to connect to said blade base by said connector pins wherein the purpose and utility of said connector pins is to provide a connection providing full rotational attachment of said replaceable blade components, allowing for complete rotational engagement with the blade base to resist impact in the event said replaceable blade component hits a hard or stationary object.

3. The replaceable rotary lawnmower blade of claim 1, further comprising:
said replaceable blade components are provided in a variety of lengths, shapes and sizes configured to a cutting diameter of the applied rotary lawnmower and are sickle shaped defining reversible dual cutting edges providing a choice between a concave cutting edge or a convex cutting edge.

4. The replaceable rotary lawnmower blade of claim 1, further comprising:
said replaceable blade components are provided in a variety of lengths, shapes and sizes configured to a cutting diameter of the applied rotary lawnmower and are rectangular presenting two identical cutting edges.

5. The replaceable rotary lawnmower blade of claim 1, further comprising:
said connector pin defines a first segment having an outer threaded shaft and an expanded head and a second segment having a smooth shaft pin having an inner threaded bore and an outer perimeter and an expanded head, said outer perimeter of said shaft pin configured to be inserted within said first end bore of said replaceable blade component and said respective connector pin bore of said blade base with said outer threaded shaft of said first segment threadably inserted within said inner threaded bore of said second segment, securing said replaceable blade component onto said respective end of said blade base, yet providing rotation of said replaceable blade component on each said of said ends of said blade base, while preventing vibration or lateral movement of either said connector pin bore or said first end bore due to a close proximity engagement of said respective bores and said outer perimeter of said smooth shaft pin of said second segment.

6. The replaceable rotary lawnmower blade of claim 1, further comprising any other element or combination of elements as disclosed in the specification and drawings.
